(19) United States
(12) Patent Application Publication
(10) Pub. No.: US 2017/0206051 A1
(43) Pub. Date: Jul. 20, 2017

(54) CONTENT SHARING METHODS AND APPARATUSES

(71) Applicant: Beijing Zhigu Rui Tuo Tech Co., Ltd, Beijing (CN)

(72) Inventors: Jia LIU, Beijing (CN); Wei SHI, Beijing (CN)

(73) Assignee: Beijing Zhigu Rui Tuo Tech Co., Ltd., Beijing (CN)

(21) Appl. No.: 15/326,439

(22) PCT Filed: Jun. 5, 2015
(86) PCT No.: PCT/CN2015/080851

§ 371 Date: Jan. 13, 2017

(30) Foreign Application Priority Data
Jul. 18, 2014 (CN) 201410344879.1

(51) Int. Cl. G06F 3/14; G06F 3/01

(52) U.S. Cl. CPC G06F 3/1454; G06F 3/013; G06F 3/1423

(57) ABSTRACT

Content sharing methods and apparatuses are provided that relate to the field of communications. A method comprises: determining position information of a projection region of a second display region of a second display device on a first display region of a first display device relative to at least one eye of a user; and acquiring related information of the projection region from the first display device according to the position information. The methods and apparatuses can simplify content sharing steps, improve content sharing efficiency and/or enhance user experience.

### RELATED APPLICATION

The present international patent cooperative treaty (PCT) application claims the benefit of priority to Chinese Patent Application No. 201410344879.1, filed on Jul. 18, 2014, and entitled “Content Sharing Method and Apparatus”, which is hereby incorporated into the present international PCT application by reference herein in its entirety.

### TECHNICAL FIELD

The present application relates to the field of communications, and in particular, to content sharing methods and apparatuses.

### BACKGROUND

With development of technologies, new display devices such as near-to-eye display devices (for example, smart glasses) and transparent screens constantly emerge, and users have more abundant and more convenient content display ways. However, compared with the traditional mobile devices (for example, smart phones and tablet computers), although the new display devices have advantages of great field of vision, being easy to wear and the like, the new display devices still have some disadvantages in aspects such as screen resolution and display effects (color saturation, brightness and contrast); while the traditional mobile devices have developed for several years, and display effects, pixel density thereof and the like have reached a higher level. Therefore, making full use of respective advantages of the traditional mobile devices and the new devices to perform display interaction and content sharing between the two kinds of devices will provide greater convenience for users.

Generally, sharing local content in which a user is interested in display content from a display device A to a display device B comprises the following steps: 1) establishing a communication connection between the device A and the device B; 2) sending, by the device A, the display content to the device B; 3) receiving, by the device B, the display content; and 4) obtaining, by the user, a region of interest through a corresponding operation (for example, zoom or take a screenshot) on the device B. The process has tedious steps, takes more time and has poor user experience.

### SUMMARY

The following presents a simplified summary of the disclosed subject matter in order to provide a basic understanding of some aspects of the disclosed subject matter. This summary is not an extensive overview of the disclosed subject matter. It is intended to neither identify key or critical elements of the disclosed subject matter nor delineate the scope of the disclosed subject matter. Its sole purpose is to present some concepts of the disclosed subject matter in a simplified form as a prelude to the more detailed description that is presented later.

An example, non-limiting objective of the present application is to provide a content sharing method and apparatus.

According to one aspect of at least one example embodiment of the present application, a content sharing method is provided, the method comprising:

determining position information of a projection region of a second display region of a second display device on a first display region of a first display device relative to at least one eye of a user; and

acquiring related information of the projection region from the first display device according to the position information.

According to one aspect of at least one example embodiment of the present application, a content sharing apparatus is provided, the apparatus comprising:

a determination module, configured to determine position information of a projection region of a second display region of a second display device on a first display region of a first display device relative to at least one eye of a user; and

an acquisition module, configured to acquire related information of the projection region from the first display device according to the position information.

The content sharing methods and apparatuses according to the example embodiments of the present application can simplify content sharing steps, improve content sharing efficiency and/or enhance user experience.

### BRIEF DESCRIPTION OF THE DRAWINGS

FIG. 1 is a flowchart of the content sharing method according to one example embodiment of the present application;

FIG. 2 is a schematic diagram of a projection region corresponding to one eye in one example embodiment of the present application;

FIG. 3 is a flowchart of step S120′ in one example embodiment of the present application;

FIG. 4 is a schematic diagram of a projection region corresponding to one eye in another example embodiment of the present application;

FIG. 5 is a schematic diagram of a projection region corresponding to two eyes in one example embodiment of the present application;

FIG. 6 is a flowchart of step S120″ in one example embodiment of the present application;

FIG. 7 is a flowchart of step S140 in one example embodiment of the present application;

FIG. 8 is a flowchart of step S140 in another example embodiment of the present application;

FIG. 9 is a schematic diagram of a modular structure of the content sharing apparatus according to one example embodiment of the present application;

FIG. 10 is a schematic diagram of a modular structure of the determination module in one example embodiment of the present application;

FIG. 11 is a schematic diagram of a modular structure of the monocular determination sub-module in one example embodiment of the present application;

FIG. 12 is a schematic diagram of a modular structure of the determination module in another example embodiment of the present application;

FIG. 13 is a schematic diagram of a modular structure of the binocular determination sub-module in one example embodiment of the present application;

FIG. 14 is a schematic diagram of a modular structure of the acquisition module in one example embodiment of the present application;

FIG. 15 is a schematic diagram of a modular structure of the acquisition module in another example embodiment of the present application; and

FIG. 16 is a schematic diagram of a modular structure of the content sharing apparatus according to one example embodiment of the present application.

### DETAILED DESCRIPTION

Example embodiments of the present application are described in detail hereinafter with reference to the accompanying drawings and embodiments. The following embodiments are intended to describe the present application, but not to limit the scope of the present application.

It should be understood by those skilled in the art that, in the embodiments of the present application, the value of the serial number of each step described above does not mean an execution sequence, and the execution sequence of each step should be determined according to the function and internal logic thereof, and should not be any limitation to the embodiments of the present application.

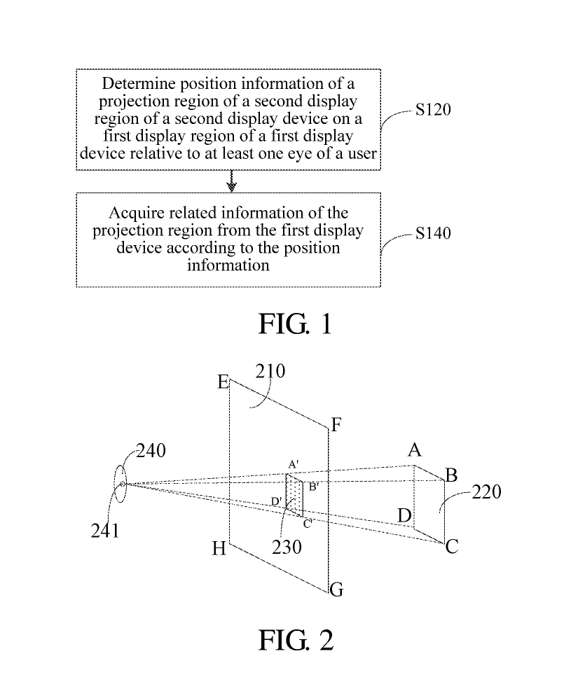

FIG. 1 is a flowchart of the content sharing method according to one embodiment of the present application. The method may be implemented on, for example, a content sharing apparatus. As shown in FIG. 1, the method comprises:

S120: determining position information of a projection region of a second display region of a second display device on a first display region of a first display device relative to at least one eye of a user; and

S140: acquiring related information of the projection region from the first display device according to the position information.

The content sharing method according to this embodiment of the present application determines position information of a projection region of a second display region of a second display device on a first display region of a first display device relative to at least one eye of a user, and then acquires related information of the projection region from the first display device according to the position information, that is to say, a user can acquire content of interest from the first display device only by adjusting the position of the first display device or the second display device to cause the projection region to cover the content of interest, thereby simplifying content sharing steps, improving content sharing efficiency and enhancing user experience.

The functions of steps S120 and S140 will be described below in detail in combination with example embodiments.

S120: Determine position information of a projection region of a second display region of a second display device on a first display region of a first display device relative to at least one eye of a user.

The at least one eye may be one eye (the left eye or the right eye) of the user, or may be two eyes (the left eye and the right eye) of the user. Description will be given below according to two situations of one eye and two eyes respectively. The first display region and the second display region may be real display regions or virtual display regions.

Firstly, in the situation of one eye, in one example embodiment, step S120 may comprise:

S120′: determining position information of a projection region of the second display region on the first display region relative to one eye of the user.

Referring to FIG. 2, the projection region 230 is a region formed by points of intersection between connecting lines from one eye 240 of the user to the second display region 220 and the first display region 210. As light enters the eye 240 through a pupil 241, it may also be said that the projection region 230 is a region formed by points of intersection between connecting lines from a pupil 241 of one eye 240 of the user to the second display region 220 and the first display region 210. In addition, the one eye may be the left eye or the right eye; their principles are the same, and will not be described respectively.

By taking FIG. 2 as an example, the projection region 230 may also be understood as a region corresponding to projection formed by convergent light emitted by a light source located on a first side of the second display region 220 on the first display region 210 located on a second side of the second display region 220. The convergent light converges into a point at the pupil 241 of the one eye 240, and the first side is a side opposite to the second side.

Referring to FIG. 3, in one example embodiment, step S120′ may comprise:

S121′: determining the position of the one eye;

S122′: determining the position of the first display region; and

S123′: determining the position information of the projection region of the second display region on the first display region relative to the one eye according to the position of the one eye and the position of the first display region.

In step S121′, an image of the one eye can be acquired, and then the position of the one eye is determined through image processing.

In step S122′, an image of the first display region can be acquired, and then the position of the first display region is determined through image processing. Alternatively, the position of the first display region may also be acquired through communication with the first display device, for example, in one example embodiment, in FIG. 2, four vertices E, F, G and H of the first display region 210 can send visible light information respectively, and the position of the first display region 210 can be determined according to the visible light information.

By still taking FIG. 2 as an example, in step S123′, suppose that the position of the first display region 210 has been determined, a projection point A′ of a vertice A of the second display region 220 on the first display region 210 (that is, a point of intersection between a connecting line from the vertice A to the eye 240 (or the pupil 241) and the first display region 210) can be computed and determined according to the position of the one eye 240 (or the pupil 241). Similarly, projection points B′, C′ and D′ corresponding to vertices B, C and D of the second display region 220 can be obtained, and the projection region 230 can be obtained by connecting the four projection points A′, B′, C′ and D′. Position information of the projection region 230 may be coordinate information of the four projection points A′, B′, C′ and D′.

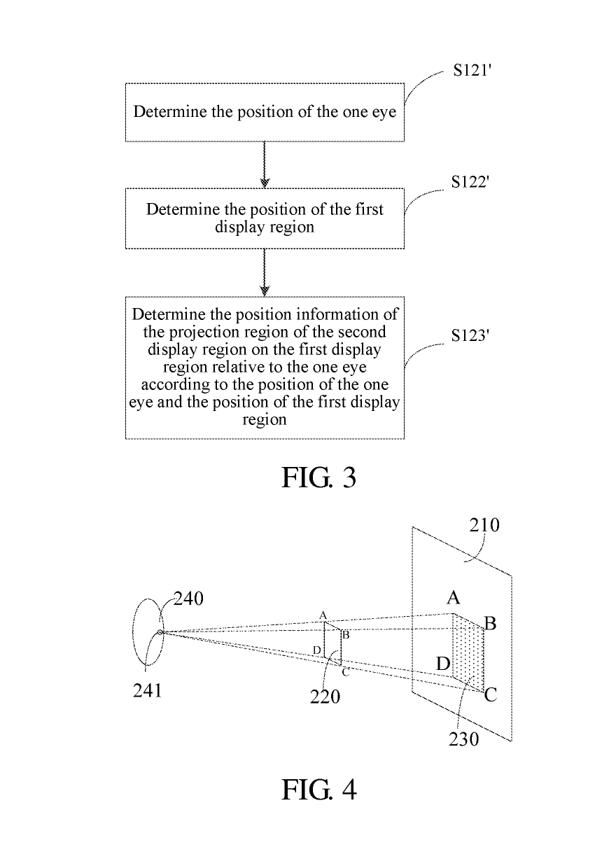

In addition, in the above example embodiments, the first display region 210 is located between the eye 240 and the second display region 220, but the present application is not limited to the position relation. Referring to FIG. 4, in the event that the second display region 220 is located between the eye 240 and the first display region 210, the projection region of the second display region 220 on the first display region 210 relative to the one eye 240 may also be determined according to the position of the first display region 210 and the position of the one eye 240; the principle thereof is similar to the above example embodiments, which is no longer described individually.

Then, in the situation of two eyes, in one example embodiment, step S120 may comprise:

S120″: determining position information of a projection region of the second display region on the first display region relative to two eyes of the user.

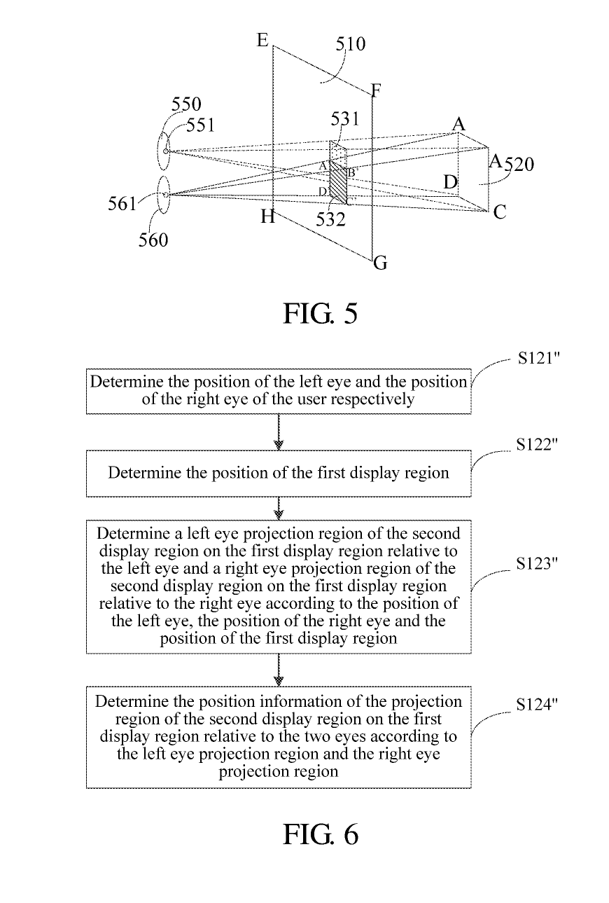

Referring to FIG. 5, in the example embodiment, the projection region is associated with a left eye projection region and a right eye projection region. The left eye projection region is a region formed by points of intersection between connecting lines from the left eye 550 of the user to the second display region 520 and the first display region 510. The right eye projection region is a region formed by points of intersection between connecting lines from the right eye 560 of the user to the second display region 520 and the first display region 510. As light enters eyes through pupils, it may also be said that the left eye projection region 531 is a region formed by points of intersection between connecting lines from the left pupil 551 of the left eye 550 of the user to the second display region 520 and the first display region 510; and the right eye projection region 532 is a region formed by points of intersection between connecting lines from the right pupil 561 of the right eye 560 of the user to the second display region 520 and the first display region 510.

Referring to FIG. 6, in one example embodiment, step S120″ may comprise:

S121″: determining the position of the left eye and the position of the right eye of the user respectively;

S122″: determining the position of the first display region;

S123″: determining a left eye projection region of the second display region on the first display region relative to the left eye and a right eye projection region of the second display region on the first display region relative to the right eye according to the position of the left eye, the position of the right eye and the position of the first display region; and

S124″: determining the position information of the projection region of the second display region on the first display region relative to the two eyes according to the left eye projection region and the right eye projection region.

In step S121″, images of the left eye and the right eye can be acquired respectively, and then the position of the left eye and the position of the right eye are determined respectively through image processing.

In step S122″, an image of the first display region can be acquired, and then the position of the first display region is determined through image processing. Alternatively, the position of the first display region may also be acquired through communication with the first display device, for example, suppose that, in FIG. 5, the first display region 510 is rectangular, four vertices E, F, G and H of the first display region 510 can send visible light information respectively, and the second display device can determine the position of the first display region 510 according to the visible light information.

By still taking FIG. 5 as an example, in step S123″, suppose that the position of the first display region 510 has been determined, a projection point A′ of a vertice A on the first display region 510 (that is, a point of intersection between a connecting line from the vertice A to the right eye 560 (or the pupil 561) and the first display region 510) can be computed and determined according to the position of the right eye 560 (or the pupil 561). Similarly, projection points B′, C′ and D′ corresponding to vertices B, C and D can be obtained, and the right eye projection region 532 can be obtained by connecting the four projection points A′, B′, C′ and D′. The above steps are repeated for the left eye 550, and the left eye projection region 531 can be obtained.

In step S124″, the projection region finally determined may comprise the left eye projection region 531 and the right eye projection region 532, or the projection region finally determined may only comprise an overlapping region of the left eye projection region 531 and the right eye projection region 532.

In addition, in the above example embodiments, the first display region 510 is located between the eyes (the left eye 550 and the right eye 560) and the second display region 520, but the present application is not limited to the position relation. In the event that the second display region 520 is located between the eyes and the first display region 510, the method of the present application may also be implemented according to the same principle, which is no longer described individually herein.

S140: Acquire related information of the projection region from the first display device according to the position information.

The related information of the projection region may comprise: display content of the projection region. The display content may be an image, a map, a document, an application window or the like.

Alternatively, the related information of the projection region may comprise: display content of the projection region, and associated information of the display content. For example, if the display content of the projection region is a local map of a certain city, the associated information may comprise views of different enlarged scales of the local map. Thus, the user can perform a zooming operation on the local map on the second display device.

Alternatively, the related information of the projection region may comprise: coordinate information of the projection region. For example, if a local map of a certain city is displayed in the projection region, the coordinate information is coordinate information (that is, latitude and longitude information) of two diagonal vertices of the local map, and according to the coordinate information, the second display device can take a screenshot of the local map on a map stored locally and display the local map to the user.

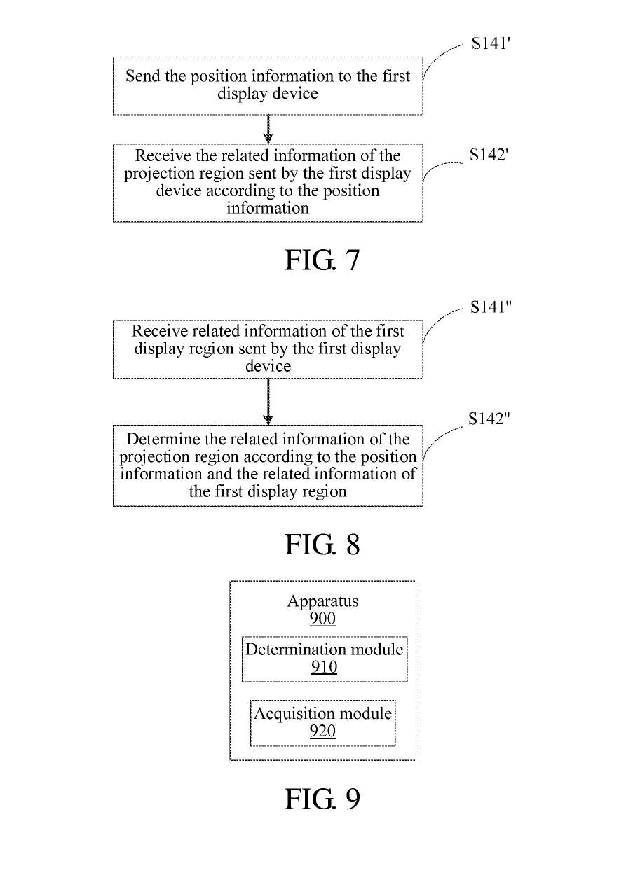

Referring to FIG. 7, in one example embodiment, step S140 may comprise:

S141′: sending the position information to the first display device; and

S142′: receiving the related information of the projection region sent by the first display device according to the position information.

By taking FIG. 5 as an example, in step S141′, coordinates of four projection points A′, B′, C′ and D′ can be sent to the first display device, and the first display device can determine the projection region in the first display region according to the coordinates of the four projection points A′, B′, C′ and D′ and then feeds back related information of the projection region.

Referring to FIG. 8, in another example embodiment, step S140 may comprise:

S141″: receiving related information of the first display region sent by the first display device; and

S142″: determining the related information of the projection region according to the position information and the related information of the first display region.

In the previous example embodiment, the first display device determines the related information of the projection region according to the related information of the first display region and the position information; the example embodiment is different from the previous example embodiment in that, the execution body of the method, for example, the content sharing apparatus, previously receives related information of the entire first display region, and then computes and determines the related information of the projection region in combination with the position information. In comparison, the previous example embodiment is conducive to reducing network traffic, but the first display device is to have certain computation capability; the example embodiment is applicable to the situation where the first display device has weaker computation capability.

In addition, in order to make the user enjoy a better display effect, resolution of the second display device may be higher than that of the first display device.

In addition, the embodiment of the present application further provides a computer readable medium, comprising a computer readable instruction that performs the following operations when being executed: executing the operations of step S120 and S140 of the method in the example embodiment shown in FIG. 1.

To sum up, according to the method in the embodiment of the present application, position information of a projection region of a second display region of a second display device on a first display region of a first display device relative to at least one eye of a user can be determined, and related information of the projection region is acquired from the first display device according to the position information, thus simplifying an operation step of sharing a part of display content on the first display device to the second display device, improving content sharing efficiency and enhancing user experience.

FIG. 9 is a schematic diagram of a modular structure of the content sharing apparatus according to one embodiment of the present application; as shown in FIG. 9, the apparatus 900 may comprise:

a determination module 910, configured to determine position information of a projection region of a second display region of a second display device on a first display region of a first display device relative to at least one eye of a user; and

an acquisition module 920, configured to acquire related information of the projection region from the first display device according to the position information.

The content sharing apparatus according to the embodiment of the present application determines position information of a projection region of a second display region of a second display device on a first display region of a first display device relative to at least one eye of a user, and then acquires related information of the projection region from the first display device according to the position information, that is to say, a user can acquire content of interest from the first display device only by adjusting the position of the first display device or the second display device to cause the projection region to cover the content of interest, thereby simplifying content sharing steps, improving content sharing efficiency and enhancing user experience.

The content sharing apparatus 900 may be disposed on the second display device as a functional module.

The functions of the determination module 910 and the acquisition module 920 will be described below in detail in combination with example embodiments.

A determination module 910, configured to determine position information of a projection region of a second display region of a second display device on a first display region of a first display device relative to at least one eye of a user.

The at least one eye may be one eye (the left eye or the right eye) of the user, or may be two eyes (the left eye and the right eye) of the user. Description will be given below according to two situations of one eye and two eyes respectively. The first display region and the second display region may be real display regions or virtual display regions.

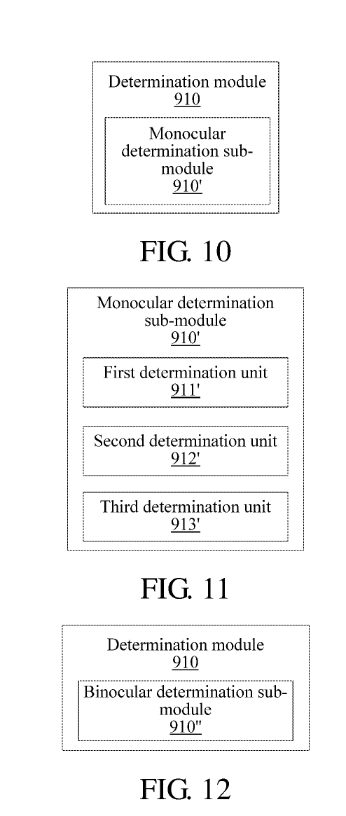

Firstly, in the situation of one eye, in one example embodiment, referring to FIG. 10, the determination module 910 comprises:

a monocular determination sub-module 910′, configured to determine position information of a projection region of the second display region on the first display region relative to one eye of the user.

Referring to FIG. 11, in one example embodiment, the monocular determination sub-module 910′ comprises:

a first determination unit 911′, configured to determine the position of the one eye;

a second determination unit 912′, configured to determine the position of the first display region; and

a third determination unit 913′, configured to determine the position information of the projection region of the second display region on the first display region relative to the one eye according to the position of the one eye and the position of the first display region.

The first determination unit 911′ can acquire an image of the one eye, and then determines the position of the one eye through image processing.

The second determination unit 912′ can acquire an image of the first display region, and then determines the position of the first display region through image processing, or can also acquire the position of the first display region through communication with the first display device. By taking FIG. 2 as an example, four vertices E, F, G and H of the first display region 210 can send visible light information respectively, and the position of the first display region 210 can be determined according to the visible light information.

By still taking FIG. 2 as an example, suppose that the position of the first display region 210 has been determined, the third determination unit 913′ can compute and determine a projection point A′ of a vertice A of the second display region 220 on the first display region 210 (that is, a point of intersection between a connecting line from the vertice A to the eye 240 (or the pupil 241) and the first display region 210) according to the position of the one eye 240 (or the pupil 241). Similarly, projection points B′, C′ and D′ corresponding to vertices B, C and D of the second display region 220 can be obtained, and the projection region 230 can be obtained by connecting the four projection points A′, B′, C′ and D′. Position information of the projection region 230 may be coordinate information of the four projection points A′, B′, C′ and D′.

In addition, in the above example embodiments, the first display region 210 is located between the eye 240 and the second display region 220, but the present application is not limited to the position relation. Referring to FIG. 4, in the event that the second display region 220 is located between the eye 240 and the first display region 210, the monocular determination sub-module 910′ may also determine the projection region of the second display region 220 on the first display region 210 relative to the one eye 240 according to the position of the first display region 210 and the position of the one eye 240; the principle thereof is similar to the above example embodiments, which is no longer described individually.

Then, in the situation of two eyes, referring to FIG. 12, in one example embodiment, the determination module 910 comprises:

a binocular determination sub-module 910″, configured to determine position information of a projection region of the second display region on the first display region relative to two eyes of the user.

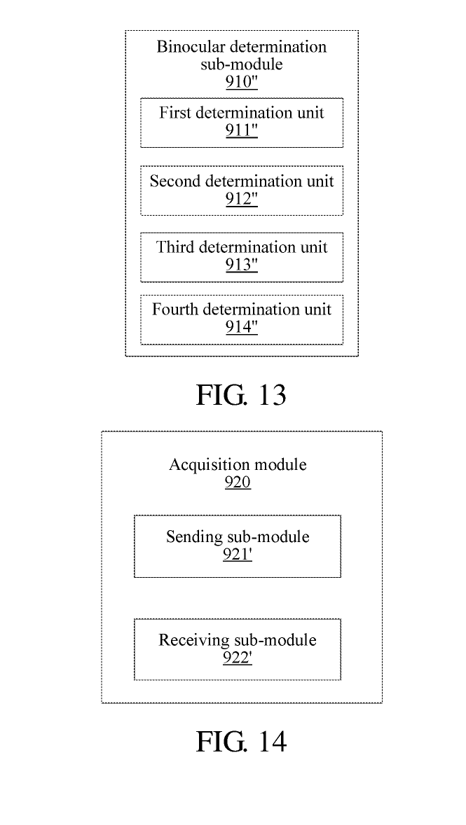

Referring to FIG. 13, in one example embodiment, the binocular determination sub-module 910″ may comprise:

a first determination unit 911″, configured to determine the position of the left eye and the position of the right eye of the user respectively;

a second determination unit 912″, configured to determine the position of the first display region;

a third determination unit 913″, configured to determine a left eye projection region of the second display region on the first display region relative to the left eye and a right eye projection region of the second display region on the first display region relative to the right eye according to the position of the left eye, the position of the right eye and the position of the first display region; and

a fourth determination unit 914″, configured to determine the position information of the projection region of the second display region on the first display region relative to the two eyes according to the left eye projection region and the right eye projection region.

The first determination unit 911″ can acquire images of the left eye and the right eye respectively, and determines then the position of the left eye and the position of the right eye respectively through image processing.

The second determination unit 912″ can acquire an image of the first display region can be acquired, and then determines the position of the first display region through image processing. Alternatively, the position of the first display region may also be acquired through communication with the first display device, for example, suppose that, in FIG. 5, the first display region 510 is rectangular, four vertices E, F, G and H of the first display region 510 can send visible light information respectively, and the second display device can determine the position of the first display region 510 according to the visible light information.

By still taking FIG. 5 as an example, suppose that the position of the first display region 510 has been determined, the third determination unit 913″ can compute and determine a projection point A′ of a vertice A on the first display region 510 (that is, a point of intersection between a connecting line from the vertice A to the right eye 560 (or the pupil 561) and the first display region 510) according to the position of the right eye 560 (or the pupil 561). Similarly, projection points B′, C′ and D′ corresponding to vertices B, C and D can be obtained, and the right eye projection region 532 can be obtained by connecting the four projection points A′, B′, C′ and D′. Likewise, the left eye projection region 531 can be obtained.

The projection region that can be finally determined by the fourth determination unit 914″ comprises the left eye projection region 531 and the right eye projection region 532, or the projection region finally determined only comprises an overlapping region of the left eye projection region 531 and the right eye projection region 532.

In addition, in the above example embodiments, the first display region 510 is located between the eyes (the left eye 550 and the right eye 560) and the second display region 520, but the present application is not limited to the position relation. In the event that the second display region 520 is located between the eyes and the first display region 510, the binocular determination sub-module 910″ may also implement the method of the present application according to the same principle, which is no longer described individually herein.

An acquisition module 920, configured to acquire related information of the projection region from the first display device according to the position information.

The related information of the projection region may comprise: display content of the projection region. The display content may be an image, a map, a document, an application window or the like.

Alternatively, the related information of the projection region may comprise: display content of the projection region, and associated information of the display content. For example, if the display content of the projection region is a local map of a certain city, the associated information may comprise views of different enlarged scales of the local map. Thus, the user can perform a zooming operation on the local map on the second display device.

Alternatively, the related information of the projection region may comprise: coordinate information of the projection region. For example, if a local map of a certain city is displayed in the projection region, the coordinate information is coordinate information (that is, latitude and longitude information) of two diagonal vertices of the local map, and according to the coordinate information, the second display device can take a screenshot of the local map on a map stored locally and display the local map to the user.

Referring to FIG. 14, in one example embodiment, the acquisition module 920 may comprise:

a sending sub-module 921′, configured to send the position information to the first display device; and

a receiving sub-module 922′, configured to receive the related information of the projection region sent by the first display device according to the position information.

By taking FIG. 5 as an example, the sending sub-module 921′ can send coordinates of four projection points A′, B′, C′ and D′ to the first display device, the first display device can determine the projection region in the first display region according to the coordinates of the four projection points A′, B′, C′ and D′ and then feeds back related information of the projection region, and then the receiving sub-module 922′ can receive the related information of the projection region.

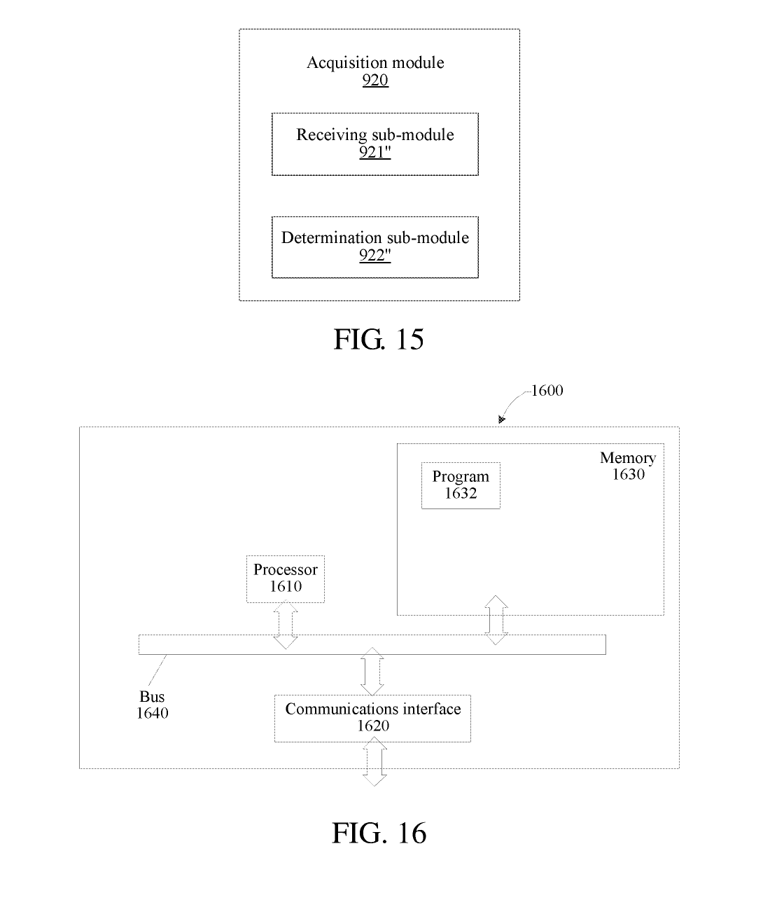

Referring to FIG. 15, in another example embodiment, the acquisition module 920 may comprise:

a receiving sub-module 921″, configured to receive related information of the first display region sent by the first display device; and

a determination sub-module 922″, configured to determine the related information of the projection region according to the position information and the related information of the first display region.

In the previous example embodiment, the first display device determines the related information of the projection region according to the related information of the first display region and the position information; the example embodiment is different from the previous example embodiment in that, the acquisition module 920 previously receives related information of the entire first display region, and then computes and determines the related information of the projection region in combination with the position information. In comparison, the previous example embodiment is conducive to reducing network traffic, but the first display device is to have certain computation capability; the example embodiment is applicable to the situation where the first display device has weaker computation capability.

In addition, in order to make the user enjoy a better display effect, resolution of the second display device may be higher than that of the first display device.

One application scenario of the content sharing method and apparatus according to the embodiments of the present application may be as follows: a user wears a pair of smart glasses to browse photos stored in the glasses, the smart glasses project the photos to eyes of the user, that is, a virtual display region is formed in front of the eyes of the user, when the user sees a group photo, he/she wants to take a screenshot of his/her own head in the group photo and transmit the screenshot to his/her mobile phone, then, the user places the mobile phone in front of the virtual display region, the user adjusts the position of the mobile phone until the projection region on the virtual display region covers his/her head and then sends a voice instruction to the smart glasses, and the smart glasses acquire his/her head from the smart glasses.

A hardware structure of the content sharing apparatus according to one embodiment of the present application is as shown in FIG. 16. The embodiment of the present application does not limit implementation of the content sharing apparatus; referring to FIG. 16, the apparatus 1600 may comprise:

a processor 1610, a Communications Interface 1620, a memory 1630, and a communications bus 1640.

The processor 1610, the Communications Interface 1620, and the memory 1630 accomplish mutual communications via the communications bus 1640.

The Communications Interface 1620 is configured to communicate with other network elements.

The processor 1610 is configured to execute a program 1632, and specifically, can implement relevant steps in the method embodiment shown in FIG. 1.

Specifically, the program 1632 may comprise a program code, the program code comprising a computer operation instruction.

The processor 1610 may be a Central Processing Unit (CPU), or an Application Specific Integrated Circuit (ASIC), or be configured to be one or more integrated circuits which implement the embodiments of the present application.

The memory 1630 is configured to store the program 1632. The memory 1630 may comprise a high-speed RAM memory, and may also comprise a non-volatile memory, for example, at least one magnetic disk memory. The program 1632 may specifically perform the following steps of:

determining position information of a projection region of a second display region of a second display device on a first display region of a first display device relative to at least one eye of a user; and

acquiring related information of the projection region from the first display device according to the position information.

Reference can be made to the corresponding description in the corresponding steps or modules in the embodiments for implementation of the steps in the program 1632, which is not repeated herein. Those skilled in the art can clearly understand that, reference can be made to the corresponding process description in the method embodiments for the devices described above and the specific working procedures of the modules, and will not be repeated herein in order to make the description convenient and concise.

It can be appreciated by those of ordinary skill in the art that each exemplary unit and method step described with reference to the embodiments disclosed herein can be implemented by electronic hardware or a combination of computer software and electronic hardware. Whether these functions are executed in a hardware mode or a software mode depends on particular applications and design constraint conditions of the technical solution. The professional technicians can use different methods to implement the functions described with respect to each particular application, but such example embodiment should not be considered to go beyond the scope of the present application.

If the functions are implemented in the form of a software functional unit and is sold or used as an independent product, it can be stored in a computer-readable storage medium. Based on such understanding, the technical solution of the present application essentially or the part which contributes to the prior art or a part of the technical solution can be embodied in the form of a software product, and the computer software product is stored in a storage medium, and comprises several instructions for enabling a computer device (which can be a personal computer, a controller, or a network device, and the like) to execute all or some steps of the method described in each embodiment of the present application. The foregoing storage medium comprises, a USB disk, a removable hard disk, a Read-Only Memory (ROM), a Random Access Memory (RAM), a magnetic disk, an optical disk or any other mediums that can store program codes.

The above example embodiments are only intended to describe the present application rather than to limit the present application; various changes and variations can be made by those of ordinary skill in the art without departing from the spirit and scope of the present application, so all equivalent technical solutions also belong to the category of the present application, and the scope of patent protection of the present application should be defined by the claims.

What is claimed is:

1. A method, comprising:
determining, by a system comprising a processor, position information of a projection region of a second display region of a second display device on a first display region of a first display device relative to at least one eye of a user; and
acquiring related information of the projection region from the first display device according to the position information.

2. The method of claim 1, wherein the determining the position comprises:
determining the position information of the projection region of the second display region on the first display region relative to one eye of the user.

3. The method of claim 2, wherein the determining the position information comprises:
determining a position of the one eye;
determining another position of the first display region; and
determining the position information of the projection region of the second display region on the first display region relative to the one eye according to the position of the one eye and the other position of the first display region.

4. The method of claim 2, wherein the projection region is a region formed by points of intersection between connecting lines from the one eye to the second display region and the first display region.

5. The method of claim 1, wherein the determining the position information comprises:
determining the position information of the projection region of the second display region on the first display region relative to two eyes of the user.

6. The method of claim 5, wherein the determining the position information comprises:
determining a first position of a left eye and a second position of a right eye of the user respectively;
determining a third position of the first display region;
determining a left eye projection region of the second display region on the first display region relative to the left eye and a right eye projection region of the second display region on the first display region relative to the right eye according to the first position of the left eye, the second position of the right eye and the third position of the first display region; and
determining the position information of the projection region of the second display region on the first display region relative to the two eyes according to the left eye projection region and the right eye projection region.

7. The method of claim 6, wherein the projection region comprises the left eye projection region and the right eye projection region.

8. The method of claim 1, wherein the acquiring the related information comprises:
sending the position information to the first display device; and
receiving the related information of the projection region sent by the first display device according to the position information.

9. The method of claim 1, wherein the acquiring the related information comprises:
receiving the related information of the first display region sent by the first display device; and
determining the related information of the projection region according to the position information and the related information of the first display region.

10. The method of claim 1, wherein the related information of the projection region comprises: display content of the projection region.

11. The method of claim 1, wherein the related information of the projection region comprises: display content of the projection region, and associated information of the display content.

12. The method of claim 1, wherein the related information of the projection region comprises: coordinate information of the projection region.

13. The method of claim 1, wherein a resolution of the second display device is higher than another resolution of the first display device.

14. An apparatus, comprising:
a memory that stores executable modules; and
a processor, coupled to the memory, that executes or facilitates execution of the executable modules, comprising:
a determination module configured to determine position information of a projection region of a second display region of a second display device on a first display region of a first display device relative to at least one eye of a user; and
an acquisition module configured to acquire related information of the projection region from the first display device according to the position information.

15. The apparatus of claim 14, wherein the determination module comprises:
a monocular determination sub-module configured to determine the position information of the projection region of the second display region on the first display region relative to one eye of the user.

16. The apparatus of claim 15, wherein the monocular determination sub-module comprises:
a first determination unit configured to determine a first position of the one eye;
a second determination unit configured to determine a second position of the first display region; and
a third determination unit configured to determine the position information of the projection region of the second display region on the first display region relative to the one eye according to the first position of the one eye and the second position of the first display region.

17. The apparatus of claim 14, wherein the determination module comprises:
a binocular determination sub-module configured to determine the position information of the projection region of the second display region on the first display region relative to two eyes of the user.

18. The apparatus of claim 17, wherein the binocular determination sub-module comprises:
a first determination unit configured to determine a first position of a left eye and a second position of a right eye of the user respectively;
a second determination unit configured to determine a third position of the first display region;
a third determination unit configured to determine a left eye projection region of the second display region on the first display region relative to the left eye and a right eye projection region of the second display region on the first display region relative to the right eye according to the first position of the left eye, the second position of the right eye and the third position of the first display region; and
a fourth determination unit configured to determine the position information of the projection region of the second display region on the first display region relative to the two eyes according to the left eye projection region and the right eye projection region.

19. The apparatus according to claim 14, wherein the acquisition module comprises:
a sending sub-module configured to send the position information to the first display device; and
a receiving sub-module configured to receive the related information of the projection region sent by the first display device according to the position information.

20. The apparatus according to claim 14, wherein the acquisition module comprises:
a receiving sub-module configured to receive related information of the first display region sent by the first display device; and
a determination sub-module configured to determine the related information of the projection region according to the position information and the related information of the first display region.

21. A computer readable storage apparatus, comprising at least one executable instruction, which, in response to execution, causes an apparatus comprising a processor to perform operations, comprising:
determining position information of a projection region of a second display region of a second display device on a first display region of a first display device relative to an eye of a user; and
acquiring related information of the projection region from the first display device according to the position information.

22. An apparatus, characterized by comprising a processor and a memory, the memory storing executable instructions, the processor being connected to the memory via a communication bus, and when the apparatus operates, the processor executes the executable instructions stored in the memory, so that the apparatus executes operations, comprising:
determining position information of a projection region of a second display region of a second display device on a first display region of a first display device relative to at least one eye determined to be associated with a user identity; and
acquiring related information of the projection region from the first display device according to the position information.
